(19) United States
(12) Patent Application Publication
(10) Pub. No.: US 2022/0410200 A1
(43) Pub. Date: Dec. 29, 2022

(54) USE OF A BLANK SHIM PLATE FOR PREVENTING DROOLING IN DIE SLOT COATING

(71) Applicant: BOSTIK SA, Colombes (FR)

(72) Inventors: Zhenjun ZHANG, Shanghai (CN); Wen LI, Shanghai (CN)

(21) Appl. No.: 17/756,307

(22) PCT Filed: Nov. 9, 2020
(86) PCT No.: PCT/EP2020/081455

§ 371 Date: May 20, 2022

(30) Foreign Application Priority Data
Nov. 22, 2019 (EP) 19306505.9

(51) Int. Cl. B05C 5/02; B05D 1/26

(52) U.S. Cl. CPC B05C 5/0254; B05D 1/26

(57) ABSTRACT

A slot coating die for applying a fluid composition on a substrate, comprising:
an upstream die part having a lower edge;
a downstream die part having a lower edge, the downstream die part facing the upstream die part and spaced apart from the upstream die part, and the lower edge of the upstream die part being vertically aligned with the lower edge of the downstream die part;
a patterned shim plate between the upstream die part and the downstream die part, the patterned shim plate having a lower edge, wherein the lower edge comprises at least one cut-out; and
a blank shim plate having a lower edge being devoid of cut-out, the blank shim plate being located between the downstream die part and the patterned shim plate; wherein at least one of the upstream die part and the downstream die part comprises at least one fluid inlet.

### TECHNICAL FIELD

The present invention relates to the use of a blank shim plate for preventing drooling of a fluid composition, in particular an adhesive composition, in a slot die coating process. The present invention further relates to a slot coating die for applying a fluid composition, in particular an adhesive composition, onto a substrate, comprising a blank shim plate. The present invention further relates to a method for applying the composition on the substrate by using said slot coating die.

### TECHNICAL BACKGROUND

Coating processes can involve the application of a thin film of fluid material to a substrate, such as for example, paper, fabric, film, foil or sheet stock. In many cases, coatings are applied to improve the surface properties of the substrate, such as the substrates appearance, adhesion, wettability, corrosion resistance, wear resistance and scratch resistance. In various cases, including printing processes and semiconductor fabrication, coatings may also form an essential part of the finished product.

A conventional slot coating die comprises an upstream part and a downstream part connected to the upstream part such as to form a cavity therebetween. Pressurized fluid is introduced into the cavity and is then dispensed from the slot coating die onto the desired substrate. A conventional slot coating die may further comprise a patterned shim which makes it possible to control the width of the coating and obtain for example stripe patterns.

However, after extended use, and notably due to the friction between the outlet of the slot coating die and the substrate, the slot coating die and more particularly the downstream part of slot coating dies tends to wear out, leading to uneven edges. As a result, the fluid material exiting the slot coating die cannot be applied evenly on the surface of the substrate and accumulates at the downstream part of the slot coating die. This phenomenon is called “drooling”. The accumulated fluid material can then contaminate the production line or the finished products, therefore leading to defective products, time-consuming production lines and even failure of the manufacture process and loss in productivity. In order to overcome these issues, the worn slot coating die must be replaced with a new one, which highly increases the overall production and maintenance costs.

Slot coating devices offered by Acumeter comprise two die parts, the lower ends of which are not vertically aligned. These devices also comprise a step plate which functions as a portion of the downstream die part.

There is thus a need for a slot coating die which makes it possible to provide good quality products in an efficient and cost-effective manner and without putting at risk the manufacture process, and to facilitate servicing of the slot coating die.

### SUMMARY OF THE INVENTION

It is a first object of the invention to provide a slot coating die for applying a fluid composition on a substrate, comprising:
an upstream die part having a lower edge;
a downstream die part having a lower edge, the downstream die part facing the upstream die part and spaced apart from the upstream die part, and the lower edge of the upstream die part being vertically aligned with the lower edge of the downstream die part;
a patterned shim plate between the upstream die part and the downstream die part, the patterned shim plate having a lower edge, wherein the lower edge comprises at least one cut-out; and
a blank shim plate having a lower edge, said lower edge being devoid of cut-out, the blank shim plate being located between the downstream die part and the patterned shim plate;

wherein at least one of the upstream die part and the downstream die part comprises at least one fluid inlet configured for making the fluid composition flow between the upstream die part and the downstream die part, and the at least one cut-out is configured for dispensing the fluid composition on the substrate.

Preferably, the slot coating die essentially consists of the upstream die part, downstream die part, patterned shim plate and black shim plate.

In some embodiments, the blank shim plate comprises at least one fluid hole through the blank shim plate, in fluid communication with at least one fluid inlet.

The blank shim plate may have a constant thickness.

In some embodiments, the blank shim plate comprises at least one fixation hole, or at least two fixation holes, or at least four fixation holes through the blank shim plate.

In some embodiments, the at least one fluid hole and/or the at least one fixation hole has a round shape.

In some embodiments, the at least one fluid hole and/or the at least one fixation hole has an elongated shape.

In some embodiments, the blank shim plate is vertically adjustable relative to the upstream die part and the downstream die part.

In some embodiments, the blank shim plate has a thickness of from 0.1 to 5 mm; preferably from 0.5 to 5 mm, and more preferably from 0.5 to 1.5 mm.

In some embodiments, the lower edge of the patterned shim plate comprises at least two, or at least three, or at least five cut-outs.

In some embodiments, the upstream die part comprises a central groove configured to receive the fluid composition from the fluid inlet(s) and to distribute it to the one or more cut-outs.

In some embodiments, the patterned shim plate further comprises at least one fluid hole, in fluid communication with at least one fluid inlet and/or at least one fixation hole through the patterned shim plate.

The invention also relates to a method for applying a fluid composition on a substrate by using the slot coating die described above, the method comprising:
feeding the fluid composition to the at least one inlet;
making the fluid composition flow between the upstream die part and the downstream die part;
dispensing the fluid composition onto the substrate through the at least one cut-out.

In some embodiments, the fluid composition is an adhesive material.

The invention also relates to the use of a blank shim plate having a lower edge, said lower edge being devoid of cut-out, for reducing or preventing drooling in a slot die coating process.

In some embodiments, the slot die coating process comprises applying a fluid composition on a substrate by a slot coating die, the slot coating die comprising:
an upstream die part having a lower edge;
a downstream die part having a lower edge, the downstream die part facing the upstream die part and spaced apart from the upstream die part, and the lower edge of the upstream die part being vertically aligned with the lower edge of the downstream die part;
a patterned shim plate between the upstream die part and the downstream die part, the patterned shim plate having a lower edge, wherein the lower edge comprises at least one cut-out;

wherein at least one of the upstream die part and the downstream die part comprises at least one fluid inlet configured for making the fluid composition flow between the upstream die part and the downstream die part, and the at least one cut-out is configured for dispensing the fluid composition on the substrate; and

wherein the blank shim plate is inserted between the downstream die part and the patterned shim plate.

In some embodiments of said use, the slot coating die is as described above.

In some embodiments of said use, the slot die coating process is continuous, or the slot die coating process is intermittent.

The present invention makes it possible to address the need mentioned above. In particular the invention provides a slot coating die which makes it possible to provide good quality products in an efficient and cost-effective manner and without putting at risk the manufacture process. Servicing of the slot coating die is also facilitated.

This is achieved by providing a blank shim plate within the slot coating die the lower edge of which is devoid of cut-outs. This blank shim plate can be placed between the conventional patterned shim plate and the downstream die part t of the slot coating die in order to provide the necessary friction between the substrate to be coated and the slot coating die and at the same time compensate the worn part of the downstream die part of the slot coating die. Thus, the presence of the blank shim plate makes it possible to avoid the accumulation of fluid material on the downstream die part of the slot coating die, which therefore leads to obtaining coated products of good quality.

Once the blank shim plate is worn out, it can easily be replaced by a new one. Thus, the replacement of the whole slot coating die is not necessary, which makes it possible to significantly reduce maintenance costs.

Advantageously, when the blank shim plate comprises one or more elongated holes, the position of the blank shim plate can be shifted over time, depending on the degree of wear; in other words the blank shim plate can be re-arranged relative to the patterned shim plate and the downstream die part, such that it can still protect the tip of the downstream die part despite being worn. In this case, the maintenance costs can be reduced even more as the immediate replacement of a worn blank shim plate is not necessary.

### BRIEF DESCRIPTION OF THE DRAWINGS

FIG. 1A illustrates a front view of a blank shim plate according to one embodiment of the present invention.

FIG. 1B illustrates a front view of a blank shim plate according to another embodiment of the present invention.

FIG. 2 illustrates a front view of an upstream die part according to one embodiment of the present invention.

FIG. 3 illustrates a front view of a downstream die part according to one embodiment of the present invention.

FIG. 4A illustrates a front view of a patterned shim plate according to one embodiment of the present invention.

FIG. 4B illustrates a front view of a patterned shim plate according to another embodiment of the present invention.

FIG. 5 illustrates a profile view of a slot coating die according to one embodiment of the present invention.

### DESCRIPTION OF EMBODIMENTS

The invention will now be described in more detail without limitation in the following description.

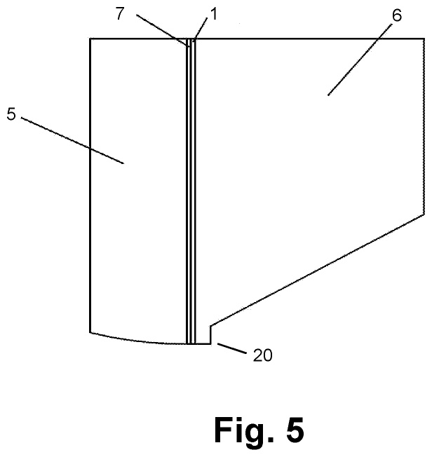

The slot coating die of the invention is described below assuming that it is oriented in the vertical direction, as shown in FIG. 5, the substrate to be coated being disposed under the slot coating die. The terms “lower”, “upper”, “vertical” and the like are used with reference to this configuration.

The terms “die” or “slot coating die” refer to a shaped body or block comprising one or more portions through which a fluid material is extruded or drawn.

Therefore, the slot coating die comprises an upstream die part 5, a downstream die part 6, as well as a blank shim plate 1 and a patterned shim plate 7 inserted (and pressed) between the upstream die part 5 and the downstream die part 6.

The blank shim plate 1 is located between the downstream die part 6 and the patterned shim plate 7. Therefore, the patterned shim plate 7 is between the upstream die part 5 and the blank shim plate 1. The slot coating die according to this embodiment is illustrated in FIG. 5. Both shim plates 1, 7 are vertically oriented.

The terms “upstream” and “downstream” refer to the direction of travel of the substrate relative to the slot coating die. The substrate travels from “upstream” to “downstream” relative to the slot coating die. To put it otherwise, the portion of the substrate situated upstream of the slot coating die has not been coated yet, whereas the portion of the substrate situated downstream of the slot coating die has already been coated.

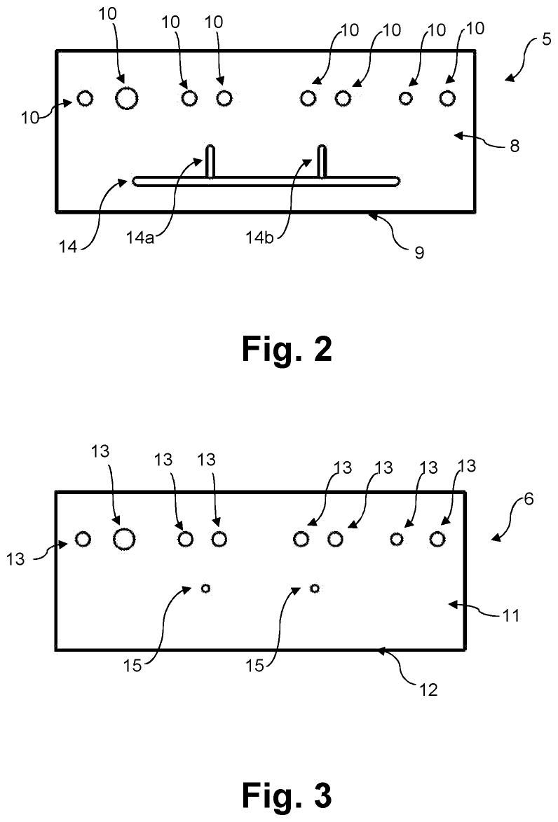

More particularly, with reference to FIG. 2, the upstream die part 5 has a first face 8 and a lower edge 9 (or coating edge). With reference to FIG. 3, the downstream die part 6 has a second face 11 and a lower edge 12 (or coating edge). The first face 8 of the upstream die part 5 faces and is parallel to the second face 11 of the downstream die part 6. Both faces are vertically oriented. The upstream die part 5 and the downstream die part 6 are spaced apart, so as to form an internal space, in which the blank shim plate 1 and the patterned shim plate 7 are inserted.

The lower edge 9 of the upstream die part 5 is aligned with the lower edge 12 of the downstream die part 6 (as can be seen on FIG. 5). In other terms, both lower edges 9, 12 are at the same vertical level; or both lower edges 9, 12 are in the same horizontal plane; or the lower edge 9 of the upstream die part 5 faces the lower edge 12 of the downstream die part 6.

The upstream die part 5 may comprise one or more fixation holes 10 on the first face 8 of the upstream die part 5. Preferably, the upstream die part 5 comprises at least two fixation holes 10, more preferably at least four fixation holes 10. For example, the upstream die part 5 may comprise one, or two, or three, or four or five or six, or more than six fixation holes 10. For example, the upstream die part 5 of FIG. 2 comprises eight fixation holes 10. It is preferable that the fixation holes 10 have a round shape. Generally, the number of fixation holes 10 is determined by the length of the upstream die part 5, the longer the upstream die part 5 is, the more fixation holes 10 are required.

By “round shape” is meant a circular shape.

The diameter of the fixation holes 10 may be from 0.5 to 20 mm and preferably from 2 to 15 mm.

Similarly, the downstream die part 6 may comprise at least one fixation hole 13 on the second face 11 of the downstream die part 6. Preferably, the downstream die part 6 comprises at least two fixation holes 13, more preferably at least four fixation holes 13. For example, the downstream die part 6 may comprise one, or two, or three, or four or five or six, or more than six fixation holes 13. For example, the downstream die part 6 of FIG. 3 comprises eight fixation holes 13. It is preferable that the fixation holes 13 have a round shape. Generally, the number of fixation holes 13 is determined by the length of the downstream die part 6, the longer the downstream die part 6 is, the more fixation holes 13 are required.

It is also preferable that the number of fixation holes 10 in the upstream die part 5 be equal to the number of fixation holes 13 in the downstream die part 6, and that the respective fixation holes 10, 13 in the two parts 5, 6 be aligned.

When the slot coating die is assembled, fixation elements are preferably inserted into the respective fixation holes 10, 13 so as to connect and firmly maintain together the upstream and downstream die parts 5, 6. Fixation elements may e.g. include pins and screws.

The blank shim plate 1 and the patterned shim plate 7 are inserted between the upstream and downstream die parts 5, 6.

By “shim plate” is meant a thin, substantially planar sheet of material.

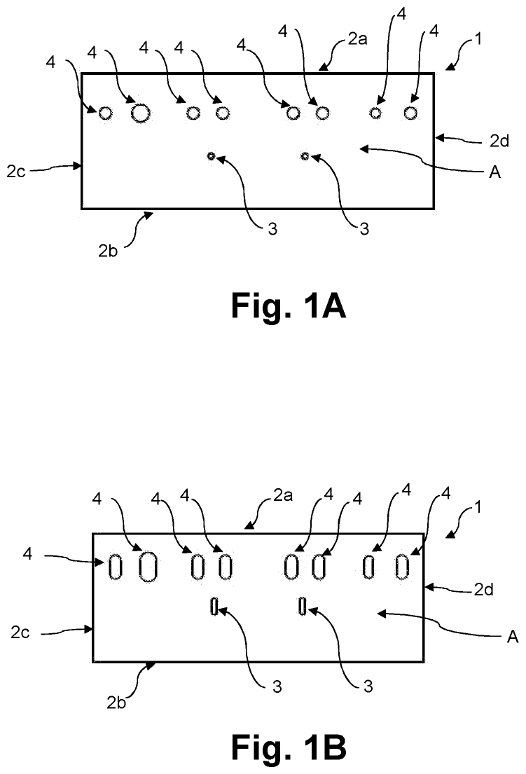

With reference to FIGS. 1A and 1B, the blank shim plate 1 may have a substantially rectangular shape. It comprises two faces (face A illustrated in the figures and face B not illustrated in the figures) and may comprise four edges. More particularly the blank shim plate 1 may comprise an upper edge 2a, a lower edge 2b, and two lateral edges 2c, 2d. Each edge of the blank shim plate 1 may be devoid of cut-outs and protrusions, in other words each edge of the blank shim plate 1 may be straight (linear).

It is preferable that the upper edge 2a and the lower edge 2b be longer than the two lateral edges 2c, 2d. In other words, it is preferable that the blank shim 1 be elongated in a horizontal direction. Naturally, the exact dimensions of the blank shim plate 1 depend on the dimensions of the upstream die part 5 and of the downstream die part 6.

For example, the upper edge 2a and the lower edge 2b can have a length from 1 to 500 cm, preferably from 5 to 300 cm, and more preferably from 10 to 100 cm.

The two lateral edges 2c, 2d can have a length from 1 to 80 cm, and more preferably from 2 to 50 cm.

The blank shim plate 1 may have a thickness from 0.1 to 5 mm; preferably from 0.5 to 5 mm; and more preferably from 0.5 to 1.5 mm. For example, the blank shim plate 1 may have a thickness from 0.1 to 0.2 mm; or from 0.2 to 0.3 mm; or from 0.3 to 0.4 mm; or from 0.4 to 0.5 mm; or from 0.5 to 0.6 mm; or from 0.6 to 0.7 mm; or from 0.7 to 0.8 mm; or from 0.8 to 0.9 mm; or from 0.9 to 1 mm; or from 1 to 1.2 mm; or from 1.2 to 1.4 mm; or from 1.4 to 1.6 mm; or from 1.6 to 1.8 mm; or from 1.8 to 2 mm; or from 2 to 2.2 mm; or from 2.2 to 2.4 mm; or from 2.4 to 2.6 mm; or from 2.6 to 2.8 mm; or from 2.8 to 3 mm; or from 3 to 3.2 mm; or from 3.2 to 3.4 mm; or from 3.4 to 3.6 mm; or from 3.6 to 3.8 mm; or from 3.8 to 4 mm; or from 4 to 4.2 mm; or from 4.2 to 4.4 mm; or from 4.4 to 4.6 mm; or from 4.6 to 4.8 mm; or from 4.8 to 5 mm. By “thickness” is meant the distance between the face A and the face B of the blank shim plate 1.

According to preferred embodiments, the blank shim plate 1 may have a constant thickness.

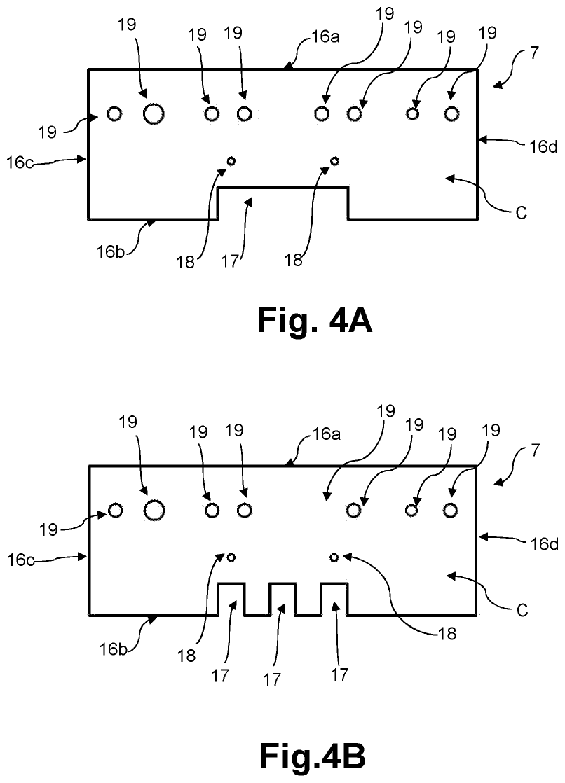

As mentioned above, the slot coating die further comprises a patterned shim plate 7 as illustrated in FIGS. 4A and 4B. The patterned shim plate 7 may for example have a rectangular shape and comprises two faces (face C illustrated in the figures and face D not illustrated in the figures) and may comprise four edges. More particularly the patterned shim plate 7 may be defined by an upper edge 16a, a lower edge 16b, and two lateral edges 16c, 16d.

It is preferable that the upper edge 16a and the lower edge 16b be longer than the two lateral edges 16c, 16d. In other words, it is preferable that the patterned shim plate 7 be elongated in a horizontal direction. It is even more preferable that the shape of the patterned shim plate 7 be substantially the same as the shape of the blank shim plate 1. Naturally, as for the blank shim plate 1, the exact dimensions of the patterned shim plate 7 depend on the dimensions of the upstream die part 5 and of the downstream die part 6.

Therefore, the upper edge 16a and the lower edge 16b can have a length e.g. from 1 to 500 cm, preferably from 5 to 300 cm, and more preferably from 10 to 100 cm.

The two lateral edges 16c, 16d can have a length e.g. from 1 to 80 cm, and more preferably from 2 to 50 cm.

According to some embodiments, the upper edge 16a of the patterned shim plate 7 has the same length as the upper edge 2a of the blank shim plate 1.

According to other embodiments, the upper edge 16a of the patterned shim plate 7 has a smaller length than the upper edge 2a of the blank shim plate 1. For example, the length of the upper edge 2a of the blank shim plate 1 may differ from (be higher than) the length of the upper edge 16a of the patterned shim plate 7 by 0.01 to 10 mm and preferably from 0.1 to 5 mm.

According to some embodiments, the lower edge 16b of the patterned shim plate 7 has the same length as the lower edge 2b of the blank shim plate 1.

According to other embodiments, the lower edge 16b of the patterned shim plate 7 has a smaller length than the lower edge 2b of the blank shim plate 1. For example, the length of the lower edge 2b of the blank shim plate 1 may differ from (be higher than) the length of the lower edge 16b of the patterned shim plate 7 by 0.01 to 10 mm, and preferably from 0.1 to 5 mm.

According to some embodiments, the two lateral edges 16c, 16d of the patterned shim plate 7 have the same length as the two lateral edges 2c, 2d of the blank shim plate 1.

According to other embodiments, the two lateral edges 16c, 16d of the patterned shim plate 7 have a smaller length than the two lateral edges 2c, 2d of the blank shim plate 1. For example, the length of the two lateral edges 2c, 2d of the blank shim plate 1 may differ from (be higher than) the length of the two lateral edges 16c, 16d of the patterned shim plate 7 by 0.01 to 1 mm, and preferably from 0.1 to 0.5 mm. Notably, the length of the two lateral edges 2c, 2d of the blank shim plate 1 may differ from (be higher than) the length of the two lateral edges 16c, 16d of the patterned shim plate 7 by 0.01 to 0.05 mm; or 0.05 to 0.1 mm.

Alternatively, the two lateral edges 16c, 16d of the patterned shim plate 7 have a higher length than the two lateral edges 2c, 2d of the blank shim plate 1. For example, the length of the two lateral edges 2c, 2d of the blank shim plate 1 may differ from (be lower than) the length of the two lateral edges 16c, 16d of the patterned shim plate 7 by 0.01 to 1 mm, and preferably from 0.1 to 0.5 mm.

The patterned shim plate 7 according to the invention may have a thickness from 0.1 to 1 mm; and preferably from 0.1 to 0.5 mm. For example, the patterned shim plate 7 may have a thickness from 0.1 to 0.2 mm; or from 0.2 to 0.3 mm; or from 0.3 to 0.4 mm; or from 0.4 to 0.5 mm; or from 0.5 to 0.6 mm; or from 0.6 to 0.7 mm; or from 0.7 to 0.8 mm; or from 0.8 to 0.9 mm; or from 0.9 to 1 mm. By “thickness” is meant the distance between face C and face D of the patterned shim plate 7.

According to some embodiments, the patterned shim plate 7 has the same thickness as the blank shim plate 1.

Alternatively, the patterned shim plate 7 may have a different thickness than the thickness of the blank shim plate 1. In this case it is preferable that the blank shim plate 1 be thicker than the patterned shim plate 7. For example, the blank shim plate 1 can be thicker than the patterned shim plate 7 by 0.05 to 1 mm, preferably from 0.1 to 0.5 mm, and even more preferably from 0.1 to 0.25 mm.

The blank shim plate 1 may further comprise at least one fixation hole 4 through its entire thickness. Preferably, the blank shim plate 1 comprises at least two fixation holes 4, more preferably at least four fixation holes 4. For example, the blank shim plate 1 may comprise one, or two, or three, or four or five or six, or more than six fixation holes 4. Generally, the number of fixation holes 4 is determined by the length of the upstream die part 5 and the length of the downstream die part 6, the longer the upstream die part 5 and the downstream die part 6 are, the more fixation holes 4 are required.

According to some embodiments, each fixation hole 4 has a round shape (as illustrated in FIG. 1A).

The fixation hole(s) 4 can have a diameter from 0.5 to 20 mm and preferably from 2 to 15 mm. The diameter is the maximum dimension of the fixation hole 4 which can be measured perpendicularly to the thickness of the plate, in the horizontal direction.

The patterned shim plate 7 may also comprise at least one fixation hole 19 through its entire thickness. Preferably, the patterned shim plate 7 comprises at least two fixation holes 19, more preferably at least four fixation holes 19. For example, the patterned shim plate 7 may comprise one, or two, or three, or four or five or six, or more than six fixation holes 19. Generally, the number of fixation holes 19 is determined by the length of the upstream die part 5 and the length of the downstream die part 6, the longer the upstream die part 5 and the downstream die part 6 are, the more fixation holes 19 are required.

As shown in FIGS. 4A and 4B, it is preferable that the fixation holes 19 of the patterned shim plate 7 have a round shape. In case the fixation holes 4 of the blank shim plate 1 have a round shape (as illustrated in FIG. 1A), it is preferable that the diameter of the fixation holes 19 of the patterned shim plate 7 should be the same as the diameter of the fixation holes 4 of the blank shim plate 1.

According to preferred embodiments, the number of fixation holes 19 of the patterned shim plate 7 is equal to the number of fixation holes 4 of the blank shim plate 1. It is also preferable that the number of fixation holes 19 of the patterned shim plate 7 and the number of fixation holes 4 of the blank shim plate 1 should be equal to the number of fixation holes 10 present on the upstream die part 5, and the number of fixation holes 13 present on the downstream die part 6.

The fixation holes 4, 19 of the blank shim plate 1 and of the patterned shim plate 7 make it possible to align and assemble both plates together with the other parts of the die. The fixation elements mentioned above may be introduced into these respective fixation holes 4, 19. For example, some of the fixation holes 4, 19 (for example one or two fixation holes 4, 19) can be used to insert pins therein. Others (for example four fixation holes 4, 19) can be used to insert screws.

The slot coating die of the present invention may comprise at least one fluid inlet 15 for introducing the fluid composition into the internal space between the upstream and downstream die parts 5, 6.

According to some embodiments, the at least one fluid inlet 15 is present on the upstream die part 5 of the slot coating die (not illustrated in the figures).

According to other embodiments, the at least one fluid inlet 15 is present on the downstream die part 6 of the slot coating die (as illustrated in FIG. 3). The downstream die part 6 illustrated in FIG. 3 comprises two fluid inlets 15, but the presence of only one fluid inlet 15, or the presence of more than two (for example three or four) fluid inlets 15 is also possible.

According to some embodiments, the slot coating die may comprise a central groove 14 for channeling the fluid composition from the one or more fluid inlet(s) 15 to the outlet(s) of the slot coating die.

In the drawings, there is a single central groove 14, in fluid communication with all the fluid inlet(s) 15. However, it is also possible to provide two or more separate central grooves 14, each central groove 14 being in fluid communication with one or more fluid inlet(s) 15.

The central groove 14 is present on the first face 8 of the upstream die part 5 of the slot coating die (as illustrated in FIG. 2).

Preferably, the central groove 14 may comprise an elongated, preferably substantially horizontal, section, configured for distributing fluid composition to a certain length of the die. In addition, the central groove 14 may comprise one or more sections 14a, 14b perpendicular to the elongated section, so as to channel the fluid composition to the elongated section.

According to some embodiments, the fluid inlet(s) 15 is(are) present on the die part (upstream or downstream) that comprises the central groove 14. In this case, the fluid inlet(s) 15 is(are) continuous with the central groove 14.

According to other embodiments, and as illustrated in the drawings, the fluid inlet(s) 15 is(are) present on the die part (upstream or downstream) which is devoid of central groove 14.

In this case, when all the parts of the slot coating die are assembled and when the fluid composition is introduced through the fluid inlet(s) 15 present for example on the downstream die part 6 as illustrated in FIG. 3, the fluid composition flows through the blank shim plate 1 and the patterned shim plate 7 before reaching the central groove 14 present on the upstream die part 5 as illustrated in FIG. 2.

The blank shim plate 1 may comprise at least one fluid hole 3 through the entire thickness of the blank shim plate 1. Similarly, the patterned shim plate 7 may comprise at least one fluid hole 18 through the entire thickness of the patterned shim plate 7. The number and positioning of the fluid holes 3, 18 then correspond to the number and positioning of the fluid inlets 15. The fluid composition is fed by the fluid inlets 15, flows through the corresponding fluid holes 3, 18 on the blank shim plate 1 and patterned shim plate 7, and then flows through the one or more central grooves 14 so as to be distributed to the outlet(s) of the slot coating die.

According to some embodiments, each fluid hole 3 on the blank shim plate 1 has a substantially round shape (as illustrated in FIG. 1A); and/or as shown in FIGS. 4A and 4B, each fluid hole 18 on the patterned shim plate 7 has a round shape.

The fluid holes 3, 18 can for example have a diameter from 0.1 to 10 mm and preferably from 4 to 5 mm.

The diameter can be measured as the maximum dimension of the hole, perpendicularly to the thickness of the plate, in the horizontal direction.

According to other, preferred embodiments, each fluid hole 3 on the blank shim plate 1 has a vertically elongated shape (as illustrated in FIG. 1B). Similarly, each fixation hole 4 on the blank shim plate 1 has a vertically elongated shape (as illustrated in FIG. 1B).

This makes it possible for the blank shim plate 1 to be vertically re-positioned or rearranged in the slot coating die relative to the other parts of the die. Thus, in case the lower edge 2b of the blank shim plate 1 starts wearing out, the blank shim plate 1 can be rearranged so that it can still protect the lower end of the downstream die part 6.

In this case, the vertical length of the fluid holes 3 may be from 5 to 50 mm. The vertical length of the fixation holes 4 may be, in this case, from 5 to 50 mm.

The lower edge 16b of the patterned shim plate 7 comprises at least one cut-out 17, preferably at least two, or at least three, or at least five cut-outs 17. For example, the patterned shim plate 7 may comprise from 1 to 3, or from 3 to 5; or from 5 to 7; or from 7 to 9; or from 9 to 11; or from 11 to 13; or from 13 to 15; or even more than 15 cut-outs 17. For example, the patterned shim plate 7 illustrated in FIG. 4A comprises a single cut-out 17 while the patterned shim plate 7 illustrated in FIG. 4B comprises three cut-outs 17. The cut-outs 17 may for example be rectangular-shaped or square-shaped. However, as the number of cut-outs 17 varies depending on the pattern, it is possible that the number of cut-outs 17 is more than 10, or more than 50, or even more than 100.

According to some embodiments, when more than one cut-outs 17 are present on the patterned shim plate 7, all cut-outs have the same horizontal length (length in a direction parallel to the upper edge 16a and the lower edge 16b of the patterned shim plate 7).

According to other embodiments, when more than one cut-outs 17 are present on the patterned shim plate 7, the length of the various cut-outs 17 may differ.

The (horizontal) length of each cut-out 17 may be for example from 1 mm to 250 cm; and preferably from 1 mm to 200 cm.

The cut-outs 17 are in fluid communication with the central groove 14. More particularly, the cut-outs 17 may be connected to the elongated section of the central groove 14.

Thus, the fluid composition flowing in the central groove 14 can exit the slot coating die from the cut-outs 17. In other terms the cut-outs 17 form the outlets of the slot coating die.

As described above, the different parts of the slot coating die can be secured together using various fastening mechanisms such as screws, bolts and pins.

Preferably, the upstream die part 5 and the downstream die part 6 can for example be manufactured from stainless steel.

The blank shim plate 1 can for example be manufactured from a material chosen from stainless steel, aluminum, ceramic, titanium, nickel, copper, tin, tungsten, molybdenum, alloys and/or combinations thereof. According to preferred embodiments, the blank shim plate 1 is manufactured from stainless steel.

The patterned shim plate 7 can be manufactured from a material chosen from stainless steel, aluminum, ceramic, titanium, nickel, copper, tin, tungsten, molybdenum, alloys and/or combinations therefore. According to preferred embodiments, the patterned shim plate 7 is manufactured from the same material as the blank shim plate 1.

In order to coat a substrate with the slot coating die of the present invention, the fluid composition is fed to the central groove(s) 14 via the fluid inlet(s) 15 and dispensed through the outlet(s) of the slot coating die. The composition can be applied in the form of patterns, especially strips, depending on the shape, number and positioning of the outlet(s) formed by the one or more cut-outs 17.

The fluid composition may be introduced into the fluid inlet(s) 15 using for example a metering pump configured to pump and transport the pressurized fluid composition through a hose and into the fluid inlet(s) 15. During this step, the fluid composition may have a temperature from 25 to 250° C.

The fluid composition is preferably an adhesive material. The adhesive material may for example comprise a rubber-based polymer such as a styrene block copolymer, butyl rubber and ethylene vinyl acetate.

The substrate may be for example a film, or a woven or nonwoven material, which may for example be made of polypropylene, polyethylene, polyethylene terephthalate, polyamide, paper or any other cellulose-based material, natural fibers such as cotton fibers, and combinations thereof.

The substrate may move from upstream to downstream. A lower part of the slot coating die may contact the substrate.

The substrate may be substantially planar. Preferably, the first face 8 of the upstream die part 5 (or the second face 11 of the downstream die part 6) form a gun deflection angle of 90° with the substrate.

Alternatively, the substrate may be deflected, i.e. the substrate may be deformed in an area of contact with the slot coating die. The portion of the substrate downstream of the slot coating die may be substantially planar; the portion of the substrate upstream of the slot coating die may be substantially planar; and both portions may form a non-zero angle.

According to some embodiments, the gun deflection angle between the first face 8 of the upstream die part 5 (or the second face 11 of the downstream die part 6) and the downstream portion of the substrate may thus be smaller than 90°, for example smaller than 80°, or smaller than 70°.

The presence of the blank shim plate 1 makes it possible to provide the necessary friction between the substrate to be coated and the slot coating die and at the same time compensate the worn part of the downstream die part 6 of the slot coating die. Thus, the presence of the blank shim plate 1 makes it possible to avoid the drooling phenomenon and improve the coating quality.

To this end, the lower edge 2b of the blank shim plate 1 may be level with the lowest portion of the downstream die part 6.

Alternatively, the lower edge 2b of the blank shim plate 1 may be lower than said lowest portion of the downstream die part 6 (lower than the lower edge 12 of the downstream die part 6), in order to protect the lowest portion of the downstream die part 6 from most of the friction with the substrate. In particular, the lowest portion of the downstream die part may be in the form of a lip 20 having a relatively low thickness, and therefore relatively susceptible to wear. The thickness of the lip 20 may range for example from 1 to 5 mm. The lower edge 2b of the blank shim plate 1 may thus be lower than the lower edge 12 of the downstream die part 6, by a distance from 0.001 to 5 mm, preferably from 0.001 to 2.5 mm, preferably from 0.001 to 1 mm, and more preferably from 0.005 to 0.5 mm.

It is worth noticing that even when the gun deflection angle is lower than 90°, which means that the friction between the slot coating die and the substrate is relatively high, the blank shim plate 1 of the present invention makes it possible to limit the wear of the slot coating die and more particularly of the downstream die part 6.

Advantageously, notably when the fluid hole (or holes) 3 and the fixation hole (or holes) 4 of the blank shim plate 1 have an elongated shape (as illustrated in FIG. 1B), when the lower edge 2b of the blank shim plate 1 starts to wear out, the blank shim plate 1 can be repositioned in the slot coating die. In other words, the blank shim plate 1 can be moved vertically, so as to compensate for the wear on the lower edge 2b of the blank shim plate 1. This makes it possible to keep using the blank shim plate 1 for a longer period of time before replacing it with a new one.

According to some preferred embodiments, the slot coating die of the present invention may essentially consist of the upstream die part (5), the downstream die part (6), the patterned shim plate (7) and the blank shim plate (1), these components being as described above. In other terms, no plate or element is interposed between the two die parts except the one blank shim plate and the one patterned shim plate. Fixation elements may however additionally be present, as disclosed above.

The temperature of the fluid exiting the slot coating die and being applied onto the substrate can be from 30 to 350° C., and preferably from 100 to 200° C.

In addition, the speed of the coating of the substrate may be from 5 to 800 m/min, and preferably from 100 to 500 m/min.

The fluid applied on the substrate may have a thickness of 0.001 to 5 mm.

According to some embodiments, the coating of a substrate with the slot coating die of the present invention may be a continuous process.

According to other embodiments, the coating of a substrate with the slot coating die of the present invention may be a discontinuous (intermittent) process.

### EXAMPLES

The following examples illustrate the invention without limiting it.

### Example 1

In this example, an ethylene vinyl acetate-based adhesive was coated on the surface of a nonwoven substrate made of polypropylene or polypropylene and polyethylene terephthalate at a temperature of 150° C. and with a speed from 100 to 600 m/min.

Coating of the substrate with the adhesive was achieved first by using a slot coating die devoid of blank shim plate and then by using a slot coating die according to the invention comprising a blank shim plate of 0.25 mm thickness. The adhesive was coated on the substrate with different quantities (g of adhesive/m²) and with different gun deflections, as illustrated in the table below.

In this example, the accumulation (drooling) of the adhesive at the downstream die part of the slot coating die was studied visually.

| | Quantity | Gun | Blank shim | |
|---|---|---|---|---|
| Test | (g/m²) | deflection (°) | plate | Result |
| 1 | 5 | 83 | No | Drooling |
| 2 | 5 | 85 | Yes | No drooling |
| 3 | 10 | 87 | No | Drooling |
| 4 | 10 | 87 | Yes | No drooling |
| 5 | 20 | 87 | No | Drooling |
| 6 | 20 | 85 | Yes | No drooling |

As shown in the table above, independently of the quantity of the adhesive and the gun deflection, the presence of the blank shim plate according to the invention made it possible to eliminate the drooling of the adhesive.

### Example 2

In this example, a styrene block copolymer based adhesive was coated on the surface of a nonwoven substrate made of polypropylene or polypropylene and polyethylene terephthalate at a temperature of 150° C. and with a speed of 100 to 600 m/min.

Coating of the substrate with the adhesive was achieved first by using a slot coating die devoid of blank shim plate and then by using a slot coating die according to the invention comprising a blank shim plate of 0.25 mm thickness. The adhesive was coated on the substrate with different quantities (g of adhesive/m²) and with different gun deflections, as illustrate in the table below.

During this example, the accumulation (drooling) of the adhesive at the downstream die part of the slot coating die was studied visually.

| | Quantity | Gun | Blank shim | |
|---|---|---|---|---|
| Test | (g/m²) | deflection (°) | plate | Result |
| 1 | 5 | 87 | No | Drooling |
| 2 | 5 | 87 | Yes | No drooling |
| 3 | 10 | 87 | No | Drooling |
| 4 | 10 | 87 | Yes | No drooling |
| 5 | 20 | 85 | Yes | No drooling |

Again, as shown in the table above, independently of the quantity of the adhesive and the gun deflection, the presence of the blank shim plate according to the invention made it possible to eliminate the drooling of the adhesive.

### Example 3

In this example, the thickness of the blank shim plate was altered in order to study the effect of this alteration on the drooling phenomenon.

Thus, the adhesive used in example 1 was coated on the surface of a substrate nonwoven substrate made of polypropylene or polypropylene and polyethylene terephthalate at a temperature of 150° C. and with a speed of 100 to 600 m/min. A quantity of 10 g/m² was coated on the substrate. The patterned shim plate used in this example had a thickness of 0.15 mm.

| | | Blank shim plate | |
|---|---|---|---|
| Test | Gun deflection (°) | thickness (mm) | Result |
| 1 | 87 | 0.15 | No drooling |
| 2 | 88 | 0.25 | No drooling |
| 3 | 86 | 0.4 | No drooling |

As shown in the table above, independently of the thickness of the blank shim plate and also independently of the difference between the thickness of the patterned shim plate and the thickness of the blank shim plate, the presence of the blank shim plate according to the invention made it possible to eliminate the drooling of the adhesive.

1. A slot coating die for applying a fluid composition on a substrate, comprising:
an upstream die part having a lower edge;
a downstream die part having a lower edge, the downstream die part facing the upstream die part and spaced apart from the upstream die part, and the lower edge of the upstream die part being vertically aligned with the lower edge of the downstream die part;
a patterned shim plate between the upstream die part and the downstream die part, the patterned shim plate having a lower edge, wherein the lower edge comprises at least one cut-out; and
a blank shim plate having a lower edge, said lower edge being devoid of cut-out, the blank shim plate being located between the downstream die part and the patterned shim plate;
wherein at least one of the upstream die part and the downstream die part comprises at least one fluid inlet configured for making the fluid composition flow between the upstream die part and the downstream die part, and the at least one cut-out is configured for dispensing the fluid composition on the substrate.

2. The slot coating die according to claim 1, wherein the blank shim plate comprises at least one fluid hole through the blank shim plate, in fluid communication with at least one fluid inlet.

3. The slot coating die according to claim 1, wherein the blank shim plate comprises at least one fixation hole through the blank shim plate.

4. The slot coating die according to claim 2, wherein the at least one fluid hole has a round shape.

5. The slot coating die according to claim 2, wherein the at least one fluid hole has an elongated shape.

6. The slot coating die according to claim 1, wherein the blank shim plate is vertically adjustable relative to the upstream die part and the downstream die part.

7. The slot coating die according to claim 1, wherein the blank shim plate has a thickness of from 0.1 to 5 mm.

8. The slot coating die according to claim 1, wherein the lower edge of the patterned shim plate comprises at least two cut-outs.

9. The slot coating die according to claim 1, wherein the upstream die part comprises a central groove configured to receive the fluid composition from the fluid inlet(s) and to distribute it to the one or more cut-outs.

10. The slot coating die according to claim 1, wherein the patterned shim plate further comprises at least one fluid hole, in fluid communication with at least one fluid inlet.

11. A method for applying a fluid composition on a substrate by using the slot coating die according to claim 1, the method comprising:
feeding the fluid composition to the at least one inlet;
making the fluid composition flow between the upstream die part and the downstream die part;
dispensing the fluid composition onto the substrate through the at least one cut-out.

12. The method according to claim 11, wherein the fluid composition is an adhesive material.

13. A method for reducing or preventing drooling in a slot die coating process, wherein the slot die coating process comprises applying a fluid composition on a substrate by a slot coating die, the slot coating die comprising
an upstream die part having a lower edge;
a downstream die part having a lower edge, the downstream die part facing the upstream die part and spaced apart from the upstream die part, and the lower edge of the upstream die part being vertically aligned with the lower edge of the downstream die part;
a patterned shim plate between the upstream die part and the downstream die part, the patterned shim plate having a lower edge, wherein the lower edge comprises at least one cut-out;
wherein at least one of the upstream die part and the downstream die part comprises at least one fluid inlet configured for making the fluid composition flow between the upstream die part and the downstream die part, and the at least one cut-out is configured for dispensing the fluid composition on the substrate; and
wherein the method comprises inserting a blank shim plate having a lower edge, said lower edge being devoid of cut-out, the downstream die part and the patterned shim plate.

14. The method of claim 13, wherein the blank shim plate comprises at least one fluid hole through the blank shim plate, in fluid communication with at least one fluid inlet.

15. The method of claim 13, wherein the slot die coating process is continuous.

16. The method of claim 13, wherein the slot die coating process is intermittent.

17. The slot coating die according to claim 1, wherein the blank shim plate has a thickness of from 0.5 to 1.5 mm.

18. The slot coating die according to claim 1, comprising at least one fixation hole through the patterned shim plate.

19. The slot coating die according to claim 3, wherein the at least one fixation hole has a round shape.

20. The slot coating die according to claim 3, wherein the at least one fixation hole has an elongated shape.
